(19) United States
(12) Patent Application Publication
(10) Pub. No.: US 2026/0310225 A1
(43) Pub. Date: Oct. 8, 2026

(54) SYSTEMS AND METHODS FOR ADAPTING OPERATING CHARACTERISTICS OF A SELF-DRIVING VEHICLE BASED ON CHANGES OF SLOPE

(71) Applicant: ROCKWELL AUTOMATION CANADA LTD., Cambridge (CA)

(72) Inventors: Robert DAM, Kitchener (CA); Ryan Christopher GARIEPY, Waterloo (CA); Nolan LUNSCHER, Kitchener (CA); Jason MERCER, Kitchener (CA); Devjit NAHA, Burlington (CA); Michael-Anthony TEDESCO, Toronto (CA)

(21) Appl. No.: 19/097,933

(22) Filed: Apr. 2, 2025

(51) Int. Cl. G05D 1/65; G05D 1/243; G06V 20/56; G05D 107/70; G05D 111/50; H04N 23/695

(52) U.S. Cl. CPC G05D 1/65; G05D 1/2435; G06V 20/588; G05D 2107/70; G05D 2111/52; H04N 23/695

(57) ABSTRACT

Systems and method of adapting operating characteristics of a self-driving vehicle to a terrain change within a vehicle path characterized by a base plane. The method involves operating a processor at the self-driving vehicle to: detect the terrain change from sensor data collected by one or more sensors coupled to the self-driving vehicle and in communication with the processor; determine, from the sensor data, an absence of navigable terrain along the base plane of the vehicle path; in response to identifying the absence of navigable terrain: continue operation while monitoring for a transition from the base plane at a downward slope; and collect slope data related to the downward slope for characterizing the terrain change; adapt the operating characteristics of the self-driving vehicle in response to the terrain change to facilitate navigation of the self-driving vehicle when entering a terrain characterized with the downward slope.

### FIELD

The described embodiments relate to systems and methods for adapting operating characteristics of a self-driving vehicle to a terrain change within a vehicle path characterized by a base plane. In particular, the systems and methods relate to adapting operating characteristics of a self-driving vehicle based on changes of slope.

### BACKGROUND

Self-driving vehicles are useful for various applications such as navigating warehouse facilities to transport materials. Self-driving vehicles are programmed to navigate complex terrain such as narrow passageways, dynamic obstacles, and uneven surfaces. To ensure that self-driving vehicles operate reliably, safety systems can be installed to accommodate navigation of complex terrain.

For example, warehouse facilities can be outfitted with guides such as magnetic tape to direct self-driving vehicles. Barriers can be erected to prevent self-driving vehicles from entering potentially dangerous areas. In addition, navigation algorithms can be used to assist self-driving vehicles with traversing a dynamic environment with various terrain changes.

### SUMMARY

The various embodiments described herein generally relate to systems and methods for adapting operating characteristics of a self-driving vehicle to a terrain change within a vehicle path characterized by a base plane.

In accordance with an example embodiment, there is provided a method of adapting operating characteristics of a self-driving vehicle to a terrain change within a vehicle path characterized by a base plane. The method involves operating a processor at the self-driving vehicle to: detect the terrain change from sensor data collected by one or more sensors coupled to the self-driving vehicle and in communication with the processor; determine, from the sensor data, an absence of navigable terrain along the base plane of the vehicle path; in response to identifying the absence of navigable terrain: continue operation while monitoring for a transition from the base plane at a downward slope; and collect slope data related to the downward slope for characterizing the terrain change; adapt the operating characteristics of the self-driving vehicle in response to the terrain change to facilitate navigation of the self-driving vehicle when entering a terrain characterized with the downward slope.

In some embodiments, operating the processor to detect the terrain change from sensor data collected by the one or more sensors coupled to the self-driving vehicle includes determining a terrain change based on a detection field.

In some embodiments, operating the processor to determine, from the sensor data, an absence of navigable terrain along the base plane of the vehicle path includes determining the absence of navigable terrain based on the sensor data and a slope detection algorithm.

In some embodiments, operating the processor to continue operation while monitoring for a transition from the base plane at a downward slope includes defining an initial operating characteristic for the self-driving vehicle based on the vehicle path associated with the base plane.

In some embodiments, operating the processor to collect slope data related to the downward slope for characterizing the terrain change includes receiving motion sensor data from at least one sensor configured to measure inertial measurement data.

In some embodiments, operating the processor to collect slope data related to the downward slope for characterizing the terrain change includes receiving vertical sensor data from at least one sensor configured to detect the absence of navigable terrain along the base plane.

In some embodiments, operating the processor to adapt the operating characteristics of the self-driving vehicle in response to the terrain change includes adjusting a speed of the self-driving vehicle.

In some embodiments, operating the processor to adapt the operating characteristics of the self-driving vehicle in response to the terrain change includes adjusting a detection field of the one or more sensors.

In some embodiments, operating the processor to adapt the operating characteristics of the self-driving vehicle in response to the terrain change includes adjusting a pitch of the at least one sensor.

In some embodiments, operating the processor to adapt the operating characteristics of the self-driving vehicle in response to the terrain change includes adjusting an operating characteristic based on a previously defined operating characteristic.

In accordance with an example embodiment, there is provided a system of adapting operating characteristics of a self-driving vehicle to a terrain change within a vehicle path characterized by a base plane. The system includes a processor configured to: detect the terrain change from sensor data collected by one or more sensors coupled to the self-driving vehicle and in communication with the processor; determine, from the sensor data, an absence of navigable terrain along the base plane of the vehicle path; in response to identifying the absence of navigable terrain: continue operation while monitoring for a transition from the base plane at a downward slope; and collect slope data related to the downward slope for characterizing the terrain change; adapt the operating characteristics of the self-driving vehicle in response to the terrain change to facilitate navigation of the self-driving vehicle when entering a terrain characterized with the downward slope.

In some embodiments, detecting the terrain change from sensor data collected by the one or more sensors coupled to the self-driving vehicle includes operating the processor to determine a terrain change based on a detection field.

In some embodiments, determining, from the sensor data, an absence of navigable terrain along the base plane of the vehicle path includes operating the processor to determine the absence of navigable terrain based on the sensor data and a slope detection algorithm.

In some embodiments, continuing operation while monitoring for a transition from the base plane at a downward slope includes operating the processor to define an initial operating characteristic for the self-driving vehicle based on the vehicle path associated with the base plane.

In some embodiments, collecting slope data related to the downward slope for characterizing the terrain change includes operating the processor to receive motion sensor data from at least one sensor configured to measure inertial measurement data.

In some embodiments, collecting slope data related to the downward slope for characterizing the terrain change includes operating the processor to receive vertical sensor data from at least one sensor configured to detect the absence of navigable terrain along the base plane.

In some embodiments, adapting the operating characteristics of the self-driving vehicle in response to the terrain change includes operating the processor to adjust a speed of the self-driving vehicle.

In some embodiments, adapting the operating characteristics of the self-driving vehicle in response to the terrain change includes operating the processor to adjust a detection field of the one or more sensors.

In some embodiments, adapting the operating characteristics of the self-driving vehicle in response to the terrain change includes operating the processor to adjust a pitch of the at least one sensor.

In some embodiments, adapting the operating characteristics of the self-driving vehicle in response to the terrain change includes operating the processor to adjust an operating characteristic based on a previously defined operating characteristic.

### BRIEF DESCRIPTION OF THE DRAWINGS

Several embodiments will now be described in detail with reference to the drawings, in which:

FIG. 1 is a block diagram of self-driving vehicles in communication with a system data storage, in accordance with at least one embodiment;

FIG. 2 is a block diagram of an example self-driving vehicle, in accordance with an at least embodiment;

FIG. 3 is a block diagram of an example self-driving vehicle, in accordance with an at least one embodiment;

FIG. 4 is a flowchart illustrating an example method for adapting operating characteristics for a self-driving vehicle, in accordance with at least one embodiment;

FIG. 5 is an illustration of an example self-driving vehicle approaching a terrain transition, in accordance with at least one embodiment; and

FIG. 6 is an illustration of an example self-driving vehicle traversing a vehicle path through terrain changes, in accordance with at least one embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Self-driving vehicles can include various sensors for sensing its environment. The various sensors can be used to facilitate autonomous navigation within the self-driving vehicle’s environment with minimal to no human input. Sensors can be used by the self-driving vehicle’s navigation system to guide self-driving-vehicle to its destination. In addition, sensors can be used by the self-driving vehicle’s safety system to ensure the self-driving vehicle reaches the destination without collisions. A self-driving vehicle may use a combination of optical, RADAR, LiDAR, SONAR, GPS, odometry, and inertial measurement sensors to perceive its surroundings.

Sensors used by the safety system ensure that collisions do not occur during operation. For example, the sensors can be positioned and configured to detect physical obstacles. The safety system can use the sensor data to prevent the self-driving vehicle from colliding with the detected obstacles. Obstacles such as pylons or bollards can be placed strategically throughout a facility to prevent self-driving vehicles from entering potentially dangerous areas. However, obstacles can be costly to erect and time-consuming to remove should there be a need to change the layout of the facility.

Further, although these self-driving vehicle sensors are suitable for detecting barriers that obstruct a vehicle path, these sensors are not suitable for detecting other obstructions, such as an absence of navigable terrain. For example, self-driving vehicles may not be able to preemptively detect when the terrain along the vehicle path transitions from flat ground to downward sloping. Without explicit barriers, self-driving vehicles risk traversing downward sloping terrain at speeds that exceed safety limits. In the worst case, self-driving vehicles may fall from a substantial height.

The embodiments described herein provide systems and methods for adapting operating characteristics of a self-driving vehicle. The described embodiments can detect terrain changes within a vehicle path and adapt the operating characteristics of the self-driving vehicle to facilitate the navigation of the terrain. In particular, the operating characteristics are adapted for navigating terrains characterized with a downward slope.

For example, as will be described in greater detail below, the self-driving vehicle can detect the terrain change from sensor data, and determine, from the sensor data, an absence of navigable terrain along the vehicle’s intended path. In response to identifying an absence of navigable terrain, the self-driving vehicle can continue operation while monitoring for a transition from the base plane at a downward slope and collect slope data related to the downward slope for characterizing the terrain change.

Accordingly, the systems and methods present a cost-effective solution to improving the safety of self-driving vehicles navigating terrain changes. In particular, the systems and methods ensure vehicles do not go beyond safe limits where the stopping range for the self-driving vehicle exceeds the ability for the self-driving vehicle to detect an absence of navigable terrain. The systems and methods ensure the self-driving vehicle’s stop range does not exceed its ability to detect an object on the downward slope that is below the detection range (i.e., that the self-driving vehicle would otherwise be able to detect if the object were on the same plane). The systems and methods also assist self-driving vehicles with avoiding hazardous scenarios such as a fall from a substantial height. In addition, the systems and methods present a solution for enforcing vehicle rated slope operating limits, before a vehicle exceeds said limits. Overall, this reduces the deployment cost by eliminating the need for installation of barriers around areas with steep slopes or sudden drop-offs that could create a hazardous situation and/or cause damage to the self-driving vehicle.

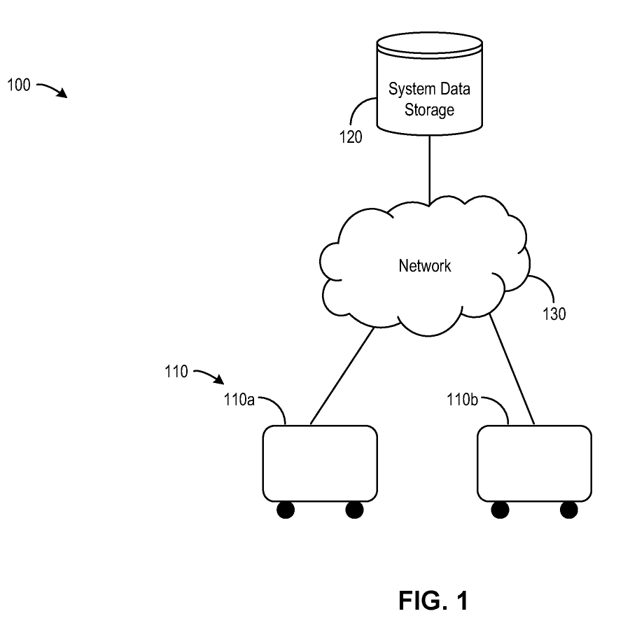

Reference is first made to FIG. 1, which illustrates a block diagram 100 which shows a block diagram 100 illustrating self-driving vehicles 110a, 110b (collectively referred to as the self-driving vehicles 110) in communication with a storage data system 120 via a network 130. While FIG. 1 shows examples of self-driving vehicles 110a, 110b for illustrative purposes, fewer or more self-driving vehicles 110 can operate with the system data storage 120.

The storage data system 120 can store data related to the self-driving vehicles 110. The system data storage can include RAM, ROM, one or more hard drives, one or more flash drives or some other suitable data storage elements such as disk drives, etc. For example, the system data storage 120 can store electronic maps related to the operating environment of the self-driving vehicles 110. The electronic maps located on the system data storage 120 can be accessible for download, via the network, by the self-driving vehicles 110.

The network 130 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the self-driving vehicles 110, and the system data storage 120. In some embodiments, the self-driving vehicles 110 can communicate with each other via the network 120. In some embodiments, vehicle 110acan communicate with vehicle 110b directly via onboard communication components. In some embodiments, the system data storage can be onboard the self-driving vehicle 110.

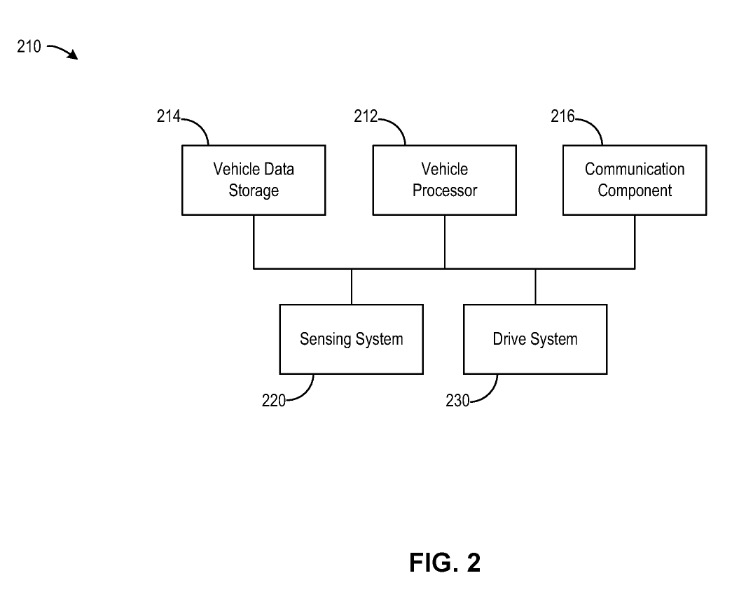

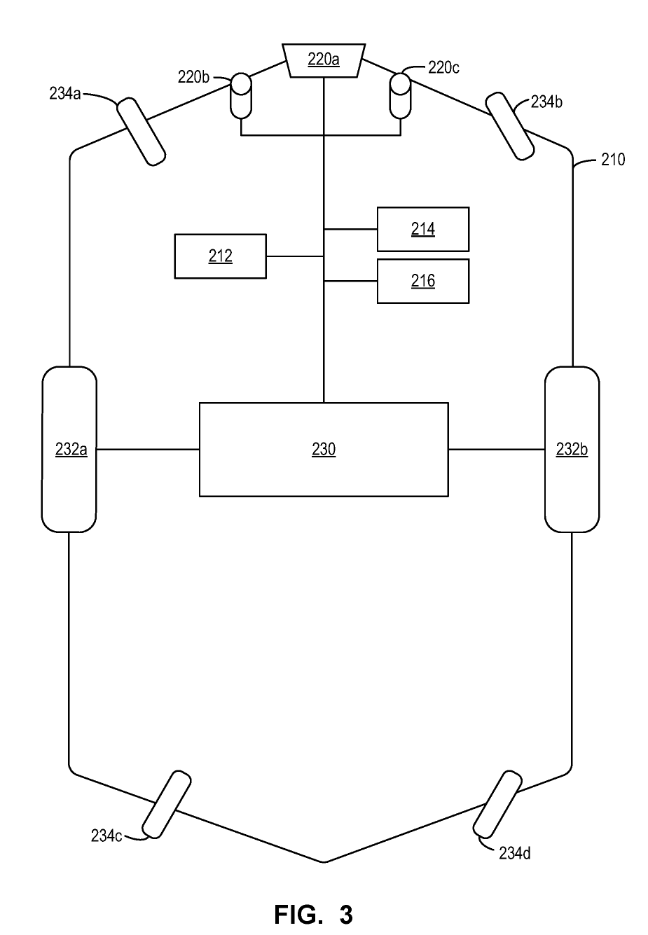

Reference is now made to FIG. 2, which illustrates a block diagram of an example self-driving vehicle 210. The self-driving vehicle 210 can include a vehicle processor 212, a vehicle data storage 214, a communication component 216, a sensing system 220, and a drive system 230. Components 212, 214, 216, 220, and 230 are illustrated separately in FIG. 3, for ease of exposition. In some embodiments, one or more of the components 212, 214, 216, 220, and 230 can be combined into fewer components, or separated into further components. In some embodiments, parts of a component can be combined with another part of another component.

The vehicle processor 212 can include any suitable processor, controller or digital signal processor that can provide sufficient processing power depending on the configuration, purposes and requirements of the self-driving vehicle 210. In some embodiments, the vehicle processor 212 can include more than one processor with each processor being configured to perform different dedicated tasks.

The vehicle processor 212 can operate the vehicle data storage 214, the communication component 216, the sensing system 220, and the drive system 230. For example, the vehicle processor 212 can operate the sensing system 220 to detect a terrain change from sensor data collected by one or more sensors coupled to the self-driving vehicle 210 and in communication with the vehicle processor 212. The vehicle processor 212 can also control the vehicle data storage 214, the communication component 216, the sensing system 220, and the drive system 230, as necessary. The operation of the vehicle processor 212 can be based on data collected from the vehicle data storage 214, the communication component 216, the sensing system 220, and/or the drive system 230, in some embodiments.

The vehicle data storage 214 can include RAM, ROM, one or more hard drives, one or more flash drives, or some other suitable data storage elements such as disk drives, etc. For example, the vehicle data storage 214 can include volatile and non-volatile memory. Non-volatile memory can store computer programs consisting of computer-executable instructions, which can be loaded into the volatile memory for execution by the vehicle processor 212. Operating the vehicle processor 212 to carry out a function can involve executing instructions (e.g., a software program) that can be stored in the vehicle data storage 214 and/or transmitting or receiving inputs and outputs via the communication component 216. The vehicle data storage 214 can also store data input to, or output from, the vehicle processor 212, which can result from the course of executing the computer-executable instructions for example.

In some embodiments, the vehicle data storage 214 can store data related to the operation of the self-driving vehicle 210, such as one or more electronic maps of its operating environment and/or operating parameters. The vehicle data storage 214 can store data tables, data processing algorithms (e.g., image processing algorithms), as well as other data and/or operating instructions which can be used by the vehicle processor 212.

The communication component 216 can include any interface that enables the self-driving vehicle 210 to communicate with other components, and external devices and systems. In some embodiments, the communication component 216 can include at least one of a serial port, a parallel port or a USB port. The communication component 216 may also include a wireless transmitter, receiver, or transceiver for communicating with a wireless communications network (e.g. using an IEEE 802.11 protocol or similar). The wireless communications network can include at least one of an Internet, Local Area Network (LAN), Ethernet, Firewire, modem or digital subscriber line connection. Various combinations of these elements may be incorporated within the communication component 216. For example, the communication component 216 may receive input from various input devices, such as a mouse, a keyboard, a touch screen, a thumbwheel, a track-pad, a track-ball, a card-reader, voice recognition software and the like depending on the requirements and implementation of the self-driving vehicle 210.

The communication component 216 can receive information about obstacles and/or unexpected objects located in the vehicle’s operating environment directly or indirectly from the system data storage 120 or from other self-driving vehicles within the same operating environment, via the network 130. The vehicle processor 212 may also transmit, via the communication component 216.

The sensing system 220 can monitor the environment of the self-driving vehicle 210. The sensing system 220 can include one or more sensors for capturing information related to the environment. The information captured by the sensing system 220 can be applied for various purposes, such as, but not limited to, localization, navigation and/mapping. For example, the sensing system 220 can include, but not limited to, optical sensors equipped with depth perception capabilities, infrared (IR) capabilities, or sonar capabilities. The optical sensors can include imaging sensors (e.g., photographic and/or video cameras), and range-finding sensors (e.g., time of flight sensors, Light Detection and Ranging (LiDAR) devices which generate and detect reflections of pulsed laser from objects proximal to the self-driving vehicle 210, etc.). The sensing system 220 can also include navigational sensors, such as ground positioning system (GPS) sensors, as well as sensors that detect guiding infrastructure installed within the operating environment. Example sensors that detect guiding infrastructure can include, but not limited to, magnetic sensors that detect magnetic tape within a facility warehouse, and/or optical sensors that detect visual navigational indicators within the operating environment. Other example sensors can include a 3D LiDAR, a 3D camera, a 2D LiDAR (vertically oriented), or a 2D camera.

The sensing system 220 can also include one or more sensors for monitoring the various components and subcomponents of the self-driving vehicle 210. In some embodiments, the sensing system can monitor the vehicle control system, the drive system 230, and/or subcomponents thereof. For example, the sensing system 220 may include, but is not limited to, sensors for measuring voltage, current, velocity, acceleration, and/or temperature.

In some embodiments, the sensing system 220 can include a sensing processor that receives data collected by the sensors and processes the collected data. The sensing processor can operate independently from the vehicle processor 212. In some other embodiments, the sensing system 220 can receive the data collected by sensors and transmit the collected data to the vehicle processor 212 for further processing.

The vehicle processor 212 can receive the data collected by the sensing system 220 and can apply the collected data to assist with navigating the self-driving vehicle 210 within its operating environment. For example, the vehicle processor 212 can receive environment data from the sensing system 220 in respect of the environment (e.g., a landmark) and can cross-reference the received environment data against the electronic map to assist with localizing the self-driving vehicle 210 and to navigate the self-driving vehicle 210 accordingly. The vehicle processor 212 can also use data collected by the sensing system 220 to determine locations for load pick-up and drop-off. For example, the sensing system 220 can collect data related to visual markers associated with pick-up and drop-off locations. The sensing system 220 can then transmit the collected data to the vehicle processor 212 for processing or can determine the associated location before transmitting the location data to the vehicle processor 212. Example visual indicators can include, but not limited to, corner tape or graphic patterns placed on the ground for identifying the pick-up or drop-off location. In some examples, the sensing system 220 can include optical sensors and/or LiDAR sensors operable for detecting the visual indicators.

The sensing system 220 can also assist the vehicle processor 212 with executing action commands. For example, when executing the action command related to a load pick-up, the sensing system 220 can operate to collect image data related to the environment of the self-driving vehicle 210 to assist the vehicle processor 212 with identifying the load and orienting with respect to the load for the pick-up.

In some embodiments, the sensing system 220 can be operated to monitor the operating environment of the self-driving vehicle 210 for the purpose of minimizing and/or avoiding collisions. The sensing system 220 can also be operated to detect an absence of navigable terrain along the vehicle path of the self-driving vehicle 210.

The sensing system 220 can include sensors dedicated for collision avoidance, in some embodiments, or can use existing sensors within the sensing system 220 for collision avoidance. In contrast with sensor data required for localization, navigation and/or mapping, the sensor data required for collision avoidance can be lower resolution. For example, sensors such as LiDAR devices and time-of-flight sensors can generate robust signals that can be quickly transmitted and processed, which can be important for collision avoidance. In some embodiments, the vehicle processor 212 can use the data collected from the sensing system 220 for avoidance detection, even though the sensor data may be higher-resolution and requires more processing time.

The vehicle processor 212 can operate the sensing system 220 to detect an obstacle within the operating environment. In response to detecting the obstacle, the vehicle processor 212 can implement a collision avoidance operation to minimize, or prevent, a collision between the self-driving vehicle 210 and the detected obstacle. Examples of collision avoidance operations can include, but are not limited to, controlling the drive system 230 to immediately stop the vehicle, cutting the power to the vehicle motor, or avoidance steering.

The sensing system 220 can also include the sensing processor in some embodiments, to assist with collision avoidance. For example, the sensing processor can receive data collected by the sensors to determine whether a collision is imminent and operate one or more collision avoidance operations. The sensing processor can include a low-level processor, such as a programmable logic controller (PLC). The PLC or other real-time controller can also be integrated with the vehicle processor 212 and used in conjunction with a higher-level processor. The sensing processor can receive, and process low-level signals generated by the sensors, and in turn, can transmit low-level output logic signals to control the drive system 230 to implement a collision avoidance operation.

The drive system 230 can include the components required for steering, driving, and stopping the self-driving vehicle 210. For example, the drive system can include a steering component and a drive motor. Specifically, the drive system 230 may include a motor and/or brakes connected to drive wheels 232a and 232b for driving the self-driving vehicle 210, as shown in FIG. 3. The motor can be, but is not limited to, an electric motor, a combustion engine, or a combination/hybrid thereof. Depending on the application of the self-driving vehicle 210, the drive system 230 may also include control interfaces that can be used for controlling the drive system 230. For example, the drive system 230 may be controlled to drive the drive wheel 232a at a different speed than the drive wheel 232b in order to turn the self-driving vehicle 210. Different embodiments may use different numbers of drive wheels, such as one, two, three, four, etc.

As shown in FIG. 3, a number of additional wheels 234 may be included. The self-driving vehicle 210 includes wheels 234a, 234b, 234c, and 234d. The wheels 234 may be wheels that are capable of allowing the autonomous mobile robot 210 to turn, such as castors, omni-directional wheels, and mecanum wheels. In some embodiments, the autonomous mobile robot 210 can be equipped with special tires for rugged surfaces or particular floor surfaces unique to its environment.

The sensing system 220 in FIG. 2 includes example vehicle sensors 220a, 220b, and 220c, as shown in FIG. 3. The sensors 220a, 220b, 220c can include, but are not limited to, optical sensors arranged to provide three-dimensional (e.g., binocular or RGB-D) imaging, two-dimensional laser scanners, and three-dimensional laser scanner.

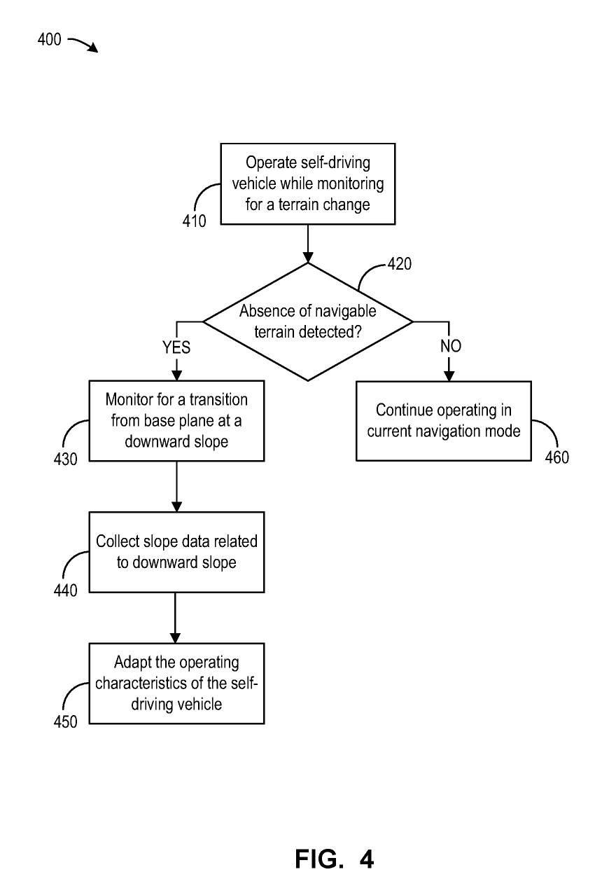

Referring now to FIG. 4, there is shown an example method 400 for adapting operating characteristics of a self-driving vehicle 210 to a terrain change within a vehicle path characterized by a base plane.

The vehicle path can be defined by a route the self-driving vehicle 210 is directed to follow. For example, the vehicle path can be defined by a route within a warehouse directing the self-driving vehicle 210 to receive a payload at point A and deposit the payload at point B.

When defined with respect to the self-driving vehicle 210, the base plane can be defined as parallel to the direction of the vehicle path. Alternatively, the base plane can also be defined with reference to the slope of the terrain the self-driving vehicle 210 is currently traversing (i.e., as determined by one or more sensors on the self-driving vehicle 210 such as an accelerometer or inertial measurement unit).

For example, the slope of the terrain can be flat (i.e., 0 degrees of inclination), uphill (i.e., greater than 0 degrees of inclination), or downhill (i.e., less than 0 degrees of inclination). Accordingly, the base plane of the vehicle path can be flat, uphill or downhill. As the self-driving vehicle 210 approaches a terrain change such as, for example, a change to the slope of the base plane (e.g., to an upward slope or to a downward slope), the system adapts operating characteristics of the self-driving vehicle 210, accordingly, as will be described herein.

The method begins at 410, the self-driving vehicle 210 operates while monitoring for a terrain change. The self-driving vehicle 210 can detect the terrain change from sensor data collected by one or more sensors coupled to the self-driving vehicle 210. The one or more sensors can be in communication with the vehicle processor 212. The sensor data can be collected from a variety of sources and can include any data related to the operating state of the self-driving vehicle 210.

The sensor data can also include data related to the environment of the self-driving vehicle 210. The vehicle processor 212 may operate the sensing system 220 to collect environmental data. For example, the vehicle processor 212 can collect obstacle data from sensors 220a or imaging data from optical sensors 220b, 220c. For instance, the vehicle processor 212 can collect data related to the velocity, distance, or position, as well as images and videos of the surroundings of the self-driving vehicle 210.

The sensor data can also include data related to the self-driving vehicle 210 itself. The vehicle processor 212 can collect vehicle data from the sensing system 220. For example, the vehicle processor 212 can collect data related to the temperature, supplied current, supplied voltage, velocity, or acceleration of one or more components of the drive system 230. The vehicle processor 212 may also collect vehicle data directly from the components and subcomponents of the self-driving vehicle 210. For example, the vehicle processor 212 can collect log files, command signals, messages, and other data from the drive system 230. The log files and other data may contain various information related to the autonomous navigation and other operations of the self-driving vehicle 210.

The sensor data can include data that has been processed, for example, by the vehicle processor 212 or by a sensing processor (not shown), or raw data that has not been processed. The vehicle processor 212 can store the collected sensor data in the vehicle data storage 214.

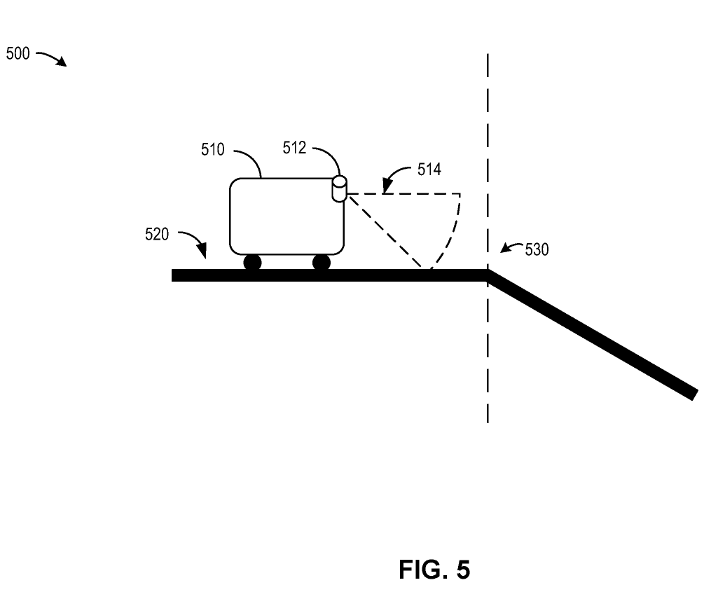

Referring to FIG. 5, a self-driving vehicle 510 traverses along a base plane 520. The base plane 520 is flat (i.e., 0 degrees of inclination). One or more sensors 512 in communication with the vehicle processor can be coupled to the self-driving vehicle 510. The one or more sensors 512 can be configured to detect terrain changes.

In some embodiments, operating the vehicle processor 212 to detect the terrain change from sensor data includes determining a terrain transition based on a detection field. For example, the one or more sensors 512 can be configured with a vertical sensor having a detection field 514. The detection field 514 can be configured to notify the vehicle processor when a terrain change is detected, such as an absence of navigable terrain.

At step 420, the vehicle processor 212 determines, from the sensor data, an absence of navigable terrain along the base plane of the vehicle path.

In some embodiments, operating the vehicle processor 212 to determine, from the sensor data, an absence of navigable terrain, along the base plane of the vehicle path includes determining the absence of navigable terrain based on the sensor data and a slope detection algorithm.

For example, the slope detection algorithm may utilize sensor data received from optical sensors (e.g., 2D-camera, 3D camera). A combination of classical computer vision or machine learning approaches for determining the slope of terrain known in the art can be used to analyze the optical data and determine the nature of the slope of the terrain. Other examples of slope detection algorithms can include curve fitting algorithms configured to extrapolate vertical sensor data received from the one or more sensors on the self-driving vehicle 210 positioned to receive vertical sensor data.

At step 430, in response to identifying the absence of navigable terrain, the self-driving vehicle 210 continues operation while monitoring for a transition from the base plane at a downward slope. The transition marks the start of the terrain change away from the base plane. For example, the transition can be defined by the intersection between the base plane and the plane defined by the downward slope characterizing the terrain change.

In some embodiments, operating the vehicle processor 212 to monitor for a transition from the base plane at a downward slope includes defining an initial operating characteristic for the self-driving vehicle 210. The initial operating characteristic can be based on the vehicle path associated with the base plane that the self-driving vehicle 210 is actively traversing.

In some embodiments, the initial operating characteristic can be defined based on a set of generalized values. The generalized values can be determined from measurements of a sample of vehicles in a controlled and representative environment. For example, the generalized values can be determined based on testing of a set of self-driving vehicles over different grades of downhill slopes.

In some embodiments, the initial operating characteristic can be defined and/or updated based on values determined from the actual performance of the self-driving vehicle in operation.

Referring to FIG. 5, the self-driving vehicle 510 traverses the base plane 520. While on the base plane 520, the self-driving vehicle 510 can define an initial operating characteristic characterized by the properties of the base plane 520. For example, since the base plane 520 is flat, the self-driving vehicle 510 can define initial operating characteristics for traversing flat terrain. The initial operating characteristics can determine the speed of self-driving vehicle 510. On a flat base plane 520, the self-driving vehicle 510 can drive up to a speed threshold suitable for flat terrain.

In other examples, when the self-driving vehicle 510 is traversing non-flat terrain (i.e., terrain that is sloped upwards or downwards), the self-driving vehicle 510 can define an initial operating characteristic that is different than the initial operating characteristic defined for flat terrain. For example, on a downward slope, the self-driving vehicle 510 can define an initial operatic characteristic suitable for terrain with a downhill slope. Accordingly, the initial operating characteristic may determine a speed threshold lower than the speed threshold for flat terrain, to prevent the self-driving vehicle 510 from operating at dangerous speeds. Defined operating characteristics can be saved in the vehicle data storage.

At step 440, the vehicle processor 212 collects slope data related to the downward slope for characterizing the terrain change. Slope data can be defined by information necessary to determine the nature of a slope such as, for example, the angle of inclination as well as the angle deviation from the base plane. Slope data can be derived from, for example, sensor data used for curve fitting, accelerometer data, and/or gyroscopic data measured by one or more sensors in communication with the vehicle processor 212.

In some embodiments, collecting slope data can include determining the absolute slope of the terrain change. For example, the absolute slope change can be determined by combining the self-driving vehicle 210 determination of the change of slope using sensors that cover the self-driving vehicle’s intended path, and a sensor that determines the self-driving vehicle’s current slope. The determination of the change of slope may be achieved via curve fitting of sensor data for the base plane and the upcoming terrain change. The sensor may include, for example, but not limited to, one or more of a 2D camera, a 3D camera, a 2D LiDAR, and a 3D LiDAR.

In some embodiments, operating the vehicle processor 212 to collect slope data related to the downward slope for characterizing the terrain change includes receiving motion sensor data from at least one sensor. The one or more sensors can be configured to measure inertial measurement data. Inertial measurement data can include, for example, position, linear and/or angular velocity, linear and/or angular acceleration, and orientation. Inertial measurement data can be measured from a variety of sensor including, but not limited to accelerometers, gyroscopes, and ultrasonic sensors.

In some embodiments, operating the vehicle processor 212 to collect slope data related to the downward slope for characterizing the terrain change includes receiving vertical sensor data from at least one sensor. The at least one sensor can be configured to detect the absence of navigable terrain along the base plane.

For example, the at least one sensor can be a single 3D camera. The 3D camera can have a 3D detection field configured to detect physical obstacles (e.g., pylons, bollards, other self-driving vehicles) along the vehicle path. The 3D camera can also be configured to detect terrain changes and terrain transitions for downward slopes from a base plane or upward slopes from a base plane.

At step 450, vehicle processor 212 adapts the operating characteristics of the self-driving vehicle 210. The operating characteristics can be adapted in response to the terrain change. The operating characteristics can be adapted to facilitate the navigation of the self-driving vehicle 210 when entering a terrain characterized with the downward slope. In some embodiments, the operating characteristics can be adapted in response to an upcoming terrain change.

Adapting the operating characteristics to facilitate the navigation of the self-driving vehicle 210 includes ensuring the integrity of the safety system. For example, the self-driving 210 can detect an upcoming downwards slope change and slows down to ensure that the self-driving vehicle’s 210 ability to stop does not exceed its ability to detect an object on that slope that may be below its detection plane, where the self-vehicle 210 would otherwise detect the object if it was on the same plane as the self-driving vehicle 210.

In some embodiments, operating the vehicle processor 212 to adapt the operating characteristics of the self-driving vehicle 210 in response to the terrain change includes adjusting the speed of the self-driving vehicle 210.

In some examples, if the absolute slope is within the rated slope of the self-driving vehicle 210, the self-driving vehicle 210 may slow down ahead of the terrain change transition. This ensures the self-driving vehicle 210 is travelling at the correct speed for the upcoming terrain change prior to driving on the terrain change. In addition, this ensures the self-driving vehicle 210 travels over the terrain change transition at an appropriate speed, which may be different than the speed required on the upcoming terrain change.

In some examples, if the upcoming absolute slope exceeds the rated slope of the self-driving vehicle 210, the self-driving vehicle 210 brings itself to a stop (e.g., as a safety-rated protective stop or a planned stop). For example, in some cases, the slope becomes a hole or a drop-off.

For example, after determining that the self-driving vehicle 210 is on a vehicle path headed toward a terrain transition marking the start of a downward slope, the vehicle processor 212 may preemptively decrease the speed of the self-driving vehicle 210. The decrease in speed facilitates safe navigation of the self-driving vehicle 210 by ensuring that the natural acceleration of the self-driving vehicle 210 as the self-driving vehicle 210 enters the terrain characterized with the downward slope does not exceed the stopping capabilities of the self-driving vehicle 210, or that traction is not lost as the self-driving vehicle 210 traverses the terrain transition.

The extent to which the vehicle processor 212 adjusts the speed of the self-driving vehicle 210 can depend on the nature of the downward slope. For example, for a gentle downward slope, the vehicle processor 212 may decrease the speed of the self-driving vehicle 210 slightly. For a moderate downward slope, the vehicle processor 212 may decrease the speed of the self-driving-vehicle 210 by a moderate amount. For a steep downward slope, the vehicle processor 212 may decrease the speed of the self-driving vehicle 210 a great amount. If the vehicle processor 212 characterizes a terrain change wherein the downward slope exceeds safe limits for navigation, the vehicle processor 212 may bring the self-driving vehicle 210 to a stop to prevent the self-driving vehicle 210 from entering the terrain.

In some embodiments, the vehicle processor 212 may adjust the speed of the self-driving vehicle 210 based on the absolute angle of inclination of the downward slope (i.e., measured by a sensor such an accelerometer). For example, a self-driving vehicle 210 may be traversing along a vehicle path on a base plane characterized by a downhill slope. The self-driving vehicle 210 may approach a terrain change characterized by an even steeper downhill slope beyond the terrain transition. Although the downward slope may be minor relative to the base plane the self-driving vehicle 210 is actively traversing (i.e., which is already sloping downhill), the absolute slope of the terrain change may exceed safe operating limits for the self-driving vehicle 210. Accordingly, the vehicle processor 212 may bring the self-driving vehicle 210 to a stop to prevent the self-driving vehicle 210 from entering the terrain.

In some embodiments, operating the vehicle processor 212 to adapt the operating characteristics of the self-driving vehicle 210 in response to the terrain change includes adjusting a detection field of the one or more sensors. In some examples, the detection field of the sensors may change to detect objects on the detected terrain change.

The detection field can define the degree of inclination for a downward slope that the self-driving vehicle 210 is rated to traverse. The detection field can be pre-determined and based on, for example, the model of self-driving vehicle 210 or the task the self-driving vehicle 210 is programmed to perform. For example, self-driving vehicles carrying heavy loads or self-driving vehicles with inadequate tire traction may be unsuitable for traversing steep downhill terrain. Accordingly, the default detection range for such vehicles may be limited to certain angles of inclination.

In some cases, the detection field may be configured based on a pre-determined threshold to allow self-driving vehicles to continue operating without a reduction in speed for terrain changes characterized by negligible downward slopes. For example, the vehicle processor 212 may detect a slight downhill transition from the base plane. However, the vehicle processor 212 may determine that the slight downhill transition does not warrant a change in operating characteristics.

In other cases, the downward slope may be inclined at a steeper angle such that the downward slope exceeds the detection range. The vehicle processor 212 may increase the detection range to attempt to locate navigable terrain at the downward slope. At the same time, the vehicle processor 212 may also decrease the speed of the self-driving vehicle 210 in response to detecting an absence of navigable terrain. If the vehicle processor 212 increases the self-driving vehicle 210 to its maximum allowable detection range without detecting navigable terrain, the vehicle processor 212 may bring the self-driving vehicle 210 to a stop and prevent the self-driving vehicle 210 from traversing the downward slope. In some examples, the downward slope may be a drop-off.

In some embodiments, operating the vehicle processor 212 to adapt the operating characteristics of the self-driving vehicle 210 in response to the terrain change includes adjusting a pitch of the at least one sensor. For example, the vehicle processor 212 may change the pitch of the at least one sensor positioned to receive vertical sensor data. The pitch may be adjusted such that the at least one sensor is capable of sensing steeper downward slope angles or detecting objects on the upcoming downward slope. In some examples, the physical orientation of the sensors can be changed.

In some embodiments, operating the vehicle processor 212 to adapt the operating characteristics of the self-driving vehicle 210 in response to the terrain change includes adjusting an operating characteristic based on a previously defined operating characteristic. At various points along a vehicle path, the self-driving vehicle 210 may be navigating terrain characterized by the same angle of inclination. For example, the self-driving vehicle 210 may drive on flat terrain (i.e., 0-degrees of inclination) for different sections along the vehicle path. The vehicle processor 212 can adapt the operating characteristics of the self-driving vehicle 210 to match the operating characteristics historically associated with driving on flat terrain.

At 420, if the vehicle processor 212 does not detect an absence of navigable terrain the method proceeds to 460. At 460, the self-driving vehicle 210 continues operation in its current navigation mode until an absence of navigable terrain is detected.

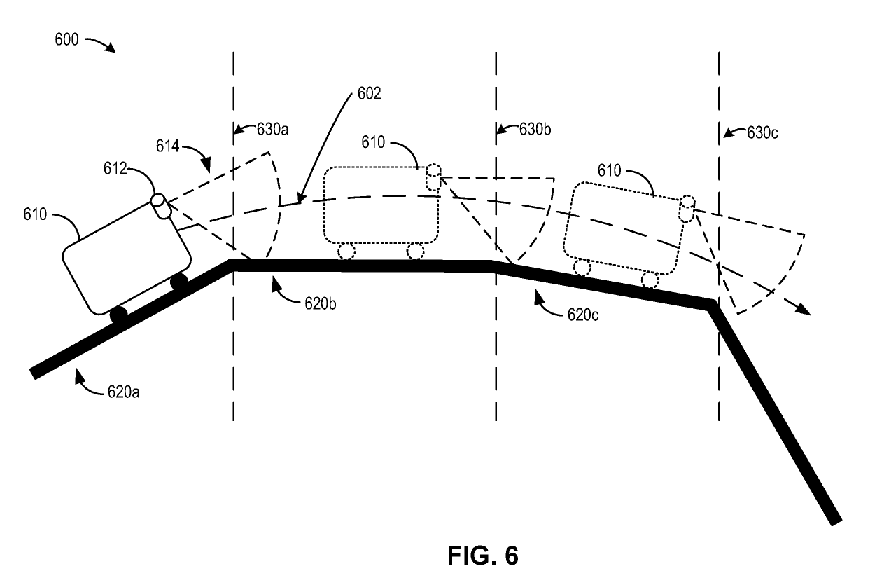

Referring now to FIG. 6, which shows an illustration 600 of an example self-driving vehicle 610 traversing a vehicle path through various terrain changes. In operation, the self-driving vehicle 610 starts on a base plane 620afollowing a vehicle path 602. The base plane 620 is upward sloping. The self-driving vehicle 610 has at least one sensor 612 configured to detect an absence of navigable terrain via a detection field 614. As the self-driving vehicle 610 approaches a terrain transition 630a, the processor adapts the operating characteristics of the self-driving vehicle 610. In this case, since the self-driving vehicle 610 is navigating an upward sloping base plane, it is likely that the self-driving vehicle 610 is applying greater power (i.e., than if the base plane were flat) to overcome the added resistance associated with traversing uphill. Accordingly, the processor can adapt the operating characteristics of the self-driving vehicle 610 to facilitate navigation when approaching the terrain transition 630a by decreasing the speed of the self-driving vehicle 610, to prepare the self-driving vehicle 610 to navigate the flat terrain. As the self-driving vehicle 610 crosses the terrain transition 630a, sensors can detect that the self-driving vehicle 610 is driving on flat terrain and further adjust the speed of the self-driving vehicle 610 accordingly. After the self-driving vehicle 610 crosses the terrain transition 630a, the self-driving vehicle 610 starts navigating along a new base plane 620b which is characterized by flat terrain.

Further along the vehicle path 602, beyond terrain transition 630a, the self-driving vehicle 610 approaches another terrain transition 630b. As the self-driving vehicle 610 approaches the terrain transition 630b, the self-driving vehicle 610 can detect an absence of navigable terrain. In this case, the self-driving vehicle 610 may not adapt the operating characteristics. For example, after collecting slope data related to the downward slope beyond terrain transition 630b, the processor may determine that the angle of inclination of the downward slope is negligible. Accordingly, the processor may determine that the current speed of the self-driving vehicle 610 is suitable for navigating the terrain beyond the terrain transition 630b, accounting for the acceleration of the self-driving vehicle 610 from traveling downhill. After the self-driving vehicle 610 crosses the terrain transition 630b, the self-driving vehicle 610 starts navigating along a new base plane 620c which is characterized by slightly downhill terrain.

Even further along the vehicle path 602, beyond terrain transition 630b, the self-driving vehicle 610 approaches another terrain transition 630c. As the self-driving vehicle 610 approaches the terrain transition 630c, the self-driving vehicle 610 can detect an absence of navigable terrain. In this case, the self-driving vehicle 610 is traversing a base plane 620c which is already slightly downhill. Since the self-driving vehicle 610 detects an absence of navigable terrain beyond terrain transition 630c, the processor may adapt the operating characteristics of the self-driving vehicle 610, anticipating terrain beyond the terrain transition 630c with an even steeper downhill slope. Accordingly, the processor can adapt the operating characteristics to decrease the speed of the self-driving vehicle 610. As the self-driving vehicle 610 approaches terrain transition 630c, the processor can also adapt the operating characteristics to increase the range of the detection field 614 for the sensor 612. In this case, sensor 612 increases the detection field to its maximum allowable range without detecting navigable terrain. Accordingly, the processor adapts the operating characteristics of the self-driving vehicle 610 by bringing the self-driving vehicle 610 to a stop, preventing the self-driving vehicle from crossing terrain transition 630c, or by slowing the self-driving vehicle 610 as it approaches the terrain transition 630c.

Unless the context requires otherwise, throughout the specification and claims which follow, the word “comprise” and variations thereof, such as, “comprises” and “comprising” are to be construed in an open, inclusive sense, that is, as “including, but not limited to.” It should be noted that terms of degree such as "substantially", "about" and “approximately" when used herein mean a reasonable amount of deviation of the modified term such that the end result is not significantly changed. These terms of degree should be construed as including a deviation of the modified term if this deviation would not negate the meaning of the term it modifies. In addition, as used herein, the wording “and/or” is intended to represent an inclusive or. That is, “X and/or Y” is intended to mean X or Y or both, for example. As a further example, “X, Y, and/or Z” is intended to mean X or Y or Z or any combination thereof. It should be noted that the term “coupled” used herein indicates that two elements can be directly coupled to one another or coupled to one another through one or more intermediate elements.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

It should also be noted that there may be some elements that are used to implement at least part of one of the embodiments described herein that may be implemented via software that is written in a high-level computer programming language such as one that employs an object-oriented paradigm. Accordingly, the program code may be written in Java, C++ or any other suitable programming language and may include modules or classes, as is known to those skilled in object-oriented programming. Alternatively, or in addition thereto, some of these elements implemented via software may be written in assembly language, machine language or firmware as needed. In either case, the language may be a compiled or interpreted language.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail since these are known to those skilled in the art. Furthermore, it should be noted that this description is not intended to limit the scope of the embodiments described herein, but rather as describing exemplary implementations. Various modifications and variations may be made to these example embodiments without departing from the spirit and scope of the invention, which is limited only by the appended claims.

1. A method of adapting operating characteristics of a self-driving vehicle to a terrain change within a vehicle path characterized by a base plane, the method comprising operating a processor at the self-driving vehicle to:
detect the terrain change from sensor data collected by one or more sensors coupled to the self-driving vehicle and in communication with the processor;
determine, from the sensor data, an absence of navigable terrain along the base plane of the vehicle path;
in response to identifying the absence of navigable terrain:
continue operation while monitoring for a transition from the base plane at a downward slope; and
collect slope data related to the downward slope for characterizing the terrain change;
adapt the operating characteristics of the self-driving vehicle in response to the terrain change to facilitate navigation of the self-driving vehicle when entering a terrain characterized with the downward slope.

2. The method of claim 1, wherein operating the processor to detect the terrain change from sensor data collected by the one or more sensors coupled to the self-driving vehicle further comprises determining a terrain change based on a detection field.

3. The method claim 1, wherein operating the processor to determine, from the sensor data, an absence of navigable terrain along the base plane of the vehicle path further comprises determining the absence of navigable terrain based on the sensor data and a slope detection algorithm.

4. The method claim 1, wherein operating the processor to continue operation while monitoring for a transition from the base plane at a downward slope further comprises defining an initial operating characteristic for the self-driving vehicle based on the vehicle path associated with the base plane.

5. The method of claim 1, wherein operating the processor to collect slope data related to the downward slope for characterizing the terrain change further comprises receiving motion sensor data from at least one sensor configured to measure inertial measurement data.

6. The method of claim 1, wherein operating the processor to collect slope data related to the downward slope for characterizing the terrain change further comprises receiving vertical sensor data from at least one sensor configured to detect the absence of navigable terrain along the base plane.

7. The method claim 1, wherein operating the processor to adapt the operating characteristics of the self-driving vehicle in response to the terrain change further comprises adjusting a speed of the self-driving vehicle.

8. The method claim 1, wherein operating the processor to adapt the operating characteristics of the self-driving vehicle in response to the terrain change further comprises adjusting a detection field of the one or more sensors.

9. The method claim 1, wherein operating the processor to adapt the operating characteristics of the self-driving vehicle in response to the terrain change further comprises adjusting a pitch of the at least one sensor.

10. The method claim 1, wherein operating the processor to adapt the operating characteristics of the self-driving vehicle in response to the terrain change further comprises adjusting an operating characteristic based on a previously defined operating characteristic.

11. A system of adapting operating characteristics of a self-driving vehicle to a terrain change within a vehicle path characterized by a base plane comprising processor operable to:
detect the terrain change from sensor data collected by one or more sensors coupled to the self-driving vehicle and in communication with the processor;
determine, from the sensor data, an absence of navigable terrain along the base plane of the vehicle path;
in response to identifying the absence of navigable terrain:
continue operation while monitoring for a transition from the base plane at a downward slope; and
collect slope data related to the downward slope for characterizing the terrain change;
adapt the operating characteristics of the self-driving vehicle in response to the terrain change to facilitate navigation of the self-driving vehicle when entering a terrain characterized with the downward slope.

12. The system of claim 11, wherein detecting the terrain change from sensor data collected by the one or more sensors coupled to the self-driving vehicle further comprises operating the processor to determine a terrain change based on a detection field.

13. The system of claim 11, wherein determining, from the sensor data, an absence of navigable terrain along the base plane of the vehicle path further comprises operating the processor to determine the absence of navigable terrain based on the sensor data and a slope detection algorithm.

14. The system of claim 11, wherein continuing operation while monitoring for a transition from the base plane at a downward slope further comprises operating the processor to define an initial operating characteristic for the self-driving vehicle based on the vehicle path associated with the base plane.

15. The system of claim 11, collecting slope data related to the downward slope for characterizing the terrain change further comprises operating the processor to receive motion sensor data from at least one sensor configured to measure inertial measurement data.

16. The system of claim 11, collecting slope data related to the downward slope for characterizing the terrain change further comprises operating the processor to receive vertical sensor data from at least one sensor configured to detect the absence of navigable terrain along the base plane.

17. The system of claim 11, wherein adapting the operating characteristics of the self-driving vehicle in response to the terrain change further comprises operating the processor to adjust a speed of the self-driving vehicle.

18. The system of claim 11, wherein adapting the operating characteristics of the self-driving vehicle in response to the terrain change further comprises operating the processor to adjust a detection field of the one or more sensors.

19. The system of claim 11, wherein adapting the operating characteristics of the self-driving vehicle in response to the terrain change further comprises operating the processor to adjust a pitch of the at least one sensor.

20. The system of claim 11, wherein adapting the operating characteristics of the self-driving vehicle in response to the terrain change further comprises operating the processor to adjust an operating characteristic based on a previously defined operating characteristic.
